(19) United States
(12) Patent Application Publication
(10) Pub. No.: US 2002/0144732 A1
(43) Pub. Date: Oct. 10, 2002

(54) Liquid flow control valve

(76) Inventor: Kah Hin Khoo, Winthrop (AU)

Correspondence Address: BIRCH STEWART KOLASCH & BIRCH, PO BOX 747, FALLS CHURCH, VA, 22040-0747, US

(21) Appl. No.: 10/096,593

(22) Filed: Mar. 14, 2002

Related U.S. Application Data
(63) Continuation of application No. PCT/AU00/01119, filed on Sep. 15, 2000.

(30) Foreign Application Priority Data
Sep. 16, 1999 (AU) PQ2934

(51) Int. Cl. F16K 31/18

(52) U.S. Cl. 137/414

(57) ABSTRACT

A liquid flow control valve comprising a casing (10) and a sealing member (22) within the casing, wherein the sealing member divides the casing into a first chamber (24) and a second chamber (26), wherein the sealing member (22) provides for restricted liquid flow (40) from the first (24) to the second chamber (26), the casing the first chamber (24) and a liquid outlet port (20), a valve operating member (32, 30) in the second chamber (26) and operable on the sealing member (22) and co-operable therewith to seal the outlet port (20), wherein the valve operating member (32, 30) is operable by liquid pressure due to liquid which flows into the second chamber (26) from the first chamber (24) via the sealing member's restricted flow passage (40) to initially co-operate with the sealing member (22) to substantially prevent liquid flow from the second chamber (26) through the outlet port (20) via the sealing member (22), and subsequently to co-operate with the sealing member (22) to seal the outlet port (20), wherein the operating member (32, 30) is externally actuable (via arm 32, typically by a float) to break the seal for liquid to flow from the first and second chambers, through the outlet port and is released upon removal of the external actuation for operation by said liquid pressure, wherein the restricted liquid flow (40) into the second chamber and the pressure thereof relative to liquid pressures at the outlet port provides for controlled closure of the valve.

The present invention relates to a liquid flow control valve. The invention has been designed especially, but not exclusively, for use in the cisterns of water closets. However, it is to be appreciated that the invention has broader application and is not limited to this particular use.

Valve assemblies have been used in water closet cisterns for many years. These are provided to regulate the flow of water into the cistern, such that a metered volume of water is able to be delivered to the water closet as desired. Generally, these arrangements are placed in the cistern and are combined with or include a float which moves with the water level in the cistern. When the float drops to a specified height, it causes the valve to open to allow water to flow into and replenish the supply of water in the cistern.

One known valve assembly used in water closet cisterns includes a poppet valve provided in a valve chamber between the inlet and outlet of the chamber. This type of valve operates by bodily lifting from its valve seat, thereby allowing water to flow from the chamber inlet to the chamber outlet. When the poppet valve is seated on the valve seat, water is prevented from flowing.

A problem with such an arrangement is that the valve is subject to easy mechanical wear because a high pressure is exerted on a small rubber seal and the valve seat ran collect dirt and debris over time, such that the ability of the valve to seal with the valve seat is reduced. Therefore, the valve and valve seat may no longer be able to create a water seal and so will require cleaning or replacement.

The present invention seeks to reduce the aforementioned problems.

According to the present invention, there is provided a liquid flow control valve comprising a casing and a sealing member within the casing, wherein the sealing member divides the casing into a first chamber and a second chamber,

wherein the sealing member provides for restricted liquid flow from the first to the second chamber,

the casing including a liquid inlet port which opens into the first chamber and a liquid outlet port,

a valve operating member in the second chamber and operable on the sealing member and co-operable therewith to seal the outlet port, wherein the valve operating member is operable by liquid pressure due to liquid which flows into the second chamber from the first chamber via the sealing member to initially co-operate with the sealing member to substantially prevent liquid flow from the second chamber through the outlet port via the sealing member, and subsequently to co-operate with the sealing member to seal the outlet port,

wherein the operating member is externally actuable to break the seal for liquid to flow from the first and second chambers through the outlet port and is released upon removal of the external actuation for operation by said liquid pressure,

wherein the restricted liquid flow into the second chamber and the pressure thereof relative to liquid pressures at the outlet port provides for controlled closure of the valve.

The invention provides an arrangement wherein during closure of the valve, there is a gradual increase in liquid pressure within the second chamber which influences the operating member. When the pressure in the second chamber increases above the liquid pressure at the outlet port, through which liquid is flowing, the operating member is caused to contact the sealing member and this substantially restricts if not prevents liquid flowing to the outlet port from the second chamber via the sealing member. The pressure in the second chamber continues to gradually increase due to the restricted liquid flow into it from the first chamber, and this then causes the operating member in conjunction with the sealing member to controllably close against the liquid flowing from the first chamber through the outlet port, until the operating member and the sealing member seal the outlet port. Thus the closing of the valve is influenced by pressure differentials between the first and second chambers, relative to pressures at the outlet port. It has been found that the controlled nature of the closing of the valve as effected by the restricted flow into the second chamber from the first chamber significantly reduces the level of water concussion which occurs upon closing of the prior art valves. A positive closure of the valve still occurs despite a lessening of the pressure differentials as the valve closes.

Preferably the valve includes a biasing means which acts on the operating member to influence it towards a sealing relationship with said sealing member to seal said outlet port to a valve closed position. This biasing means, which may be a helical spring acting between the casing and the operating member, need provide only a weak influencing force on the operating member. Its function is to improve the positive closure of the valve without unduly increasing the water concussion upon closing.

Preferably the outlet port is formed in a valve seat located within the first chamber adjacent the sealing member and preferably the sealing member is both movable within the casing and formed from a resilient material. The operating member may include a stem which passes through an aperture in the sealing member and through the outlet port, wherein the stem provides for external actuation of the operating member.

The sealing member may provide for restricted liquid flow from the first to the second chamber by means of one or more small apertures therethrough, preferably however the sealing member in co-operation with the casing wall provides for such restricted flow. For example, one or more small passageways between the first and the second chambers may be defined by the sealing member in conjunction with the casing wall. Such passageways could be provided for example by grooves or slits in a side surface of the sealing member. Alternatively ribs could be provided on such side surface or on the casing wall.

A sealing member which is resiliently flexible is particularly preferred because it assists self cleaning of the valve and thus addresses the above-mentioned second problem. Such self cleaning occurs upon closure of the valve wherein the positive closure, as described above, is sufficient to resiliently flex the sealing member and so dislodge any dirt or debris therefrom or which may be on or near the valve seat.

The valve is preferably part of an inlet valve assembly for a cistern. Such an assembly preferably includes a mechanism for actuating the operating member dependent upon a water level in a cistern and for this purpose the mechanism may be connectable to a float. In an above described preferred embodiment wherein the valve operating member includes a stem, the actuating mechanism is preferably operable to move the stem sideways to tilt or cant the operating member and thus break the seal at the valve outlet port for water to flow into and fill the cistern. When the cistern fills to a predetermined level, the float moves the actuating mechanism such that the valve operating member is released for it to controllably close the valve. Other arrangements are clearly possible, for example the actuating mechanism could be operable on the operating member for it to move axially.

Preferably the cistern inlet valve assembly includes inlet and outlet conduits communicating with, respectively, the inlet and outlet ports of the valve, which are each telescopically variable in length to enable the assembly to be fitted in a variety of cisterns. Such a feature allows an inlet valve assembly to be fitted at variable heights relative to a cistern.

A preferred embodiment of the invention will now be described, by way of non-limiting example only, with reference to the accompanying drawings. In the drawings

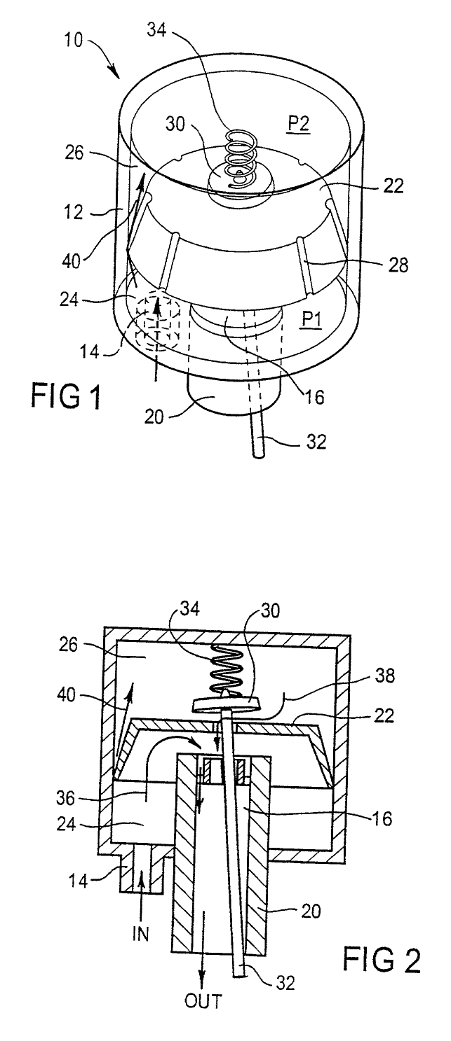

FIG. 1 is a diagrammatic illustration of a preferred valve according to the invention.

FIG. 2 is a schematic side sectional view of the valve of FIG. 1.

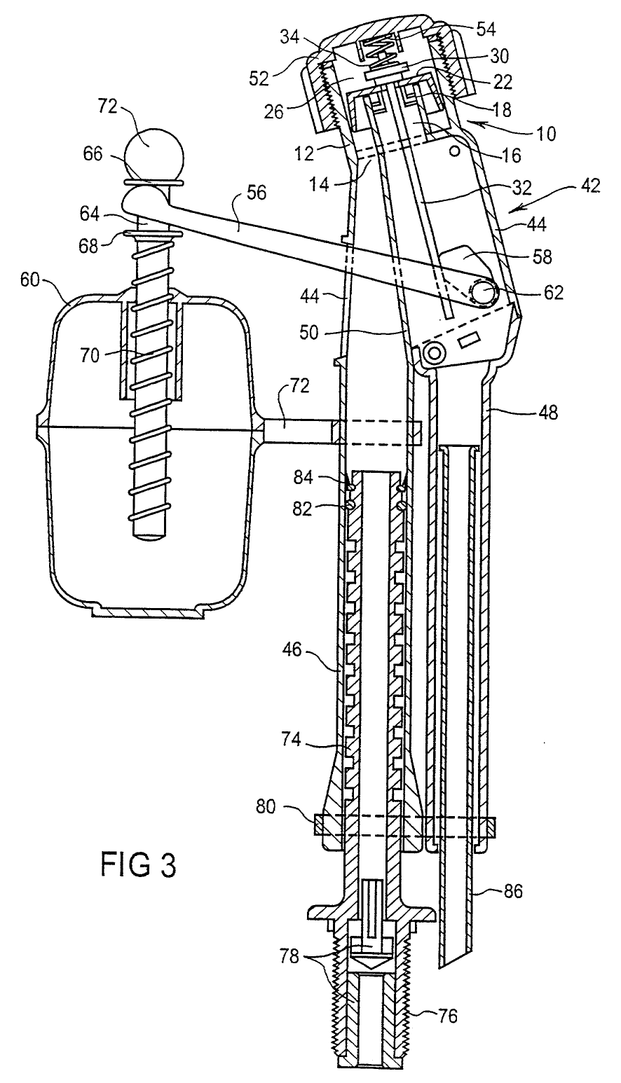

FIG. 3 is a sectional view of a cistern inlet valve assembly which includes a valve of the type shown in FIGS. 1 and 2; and

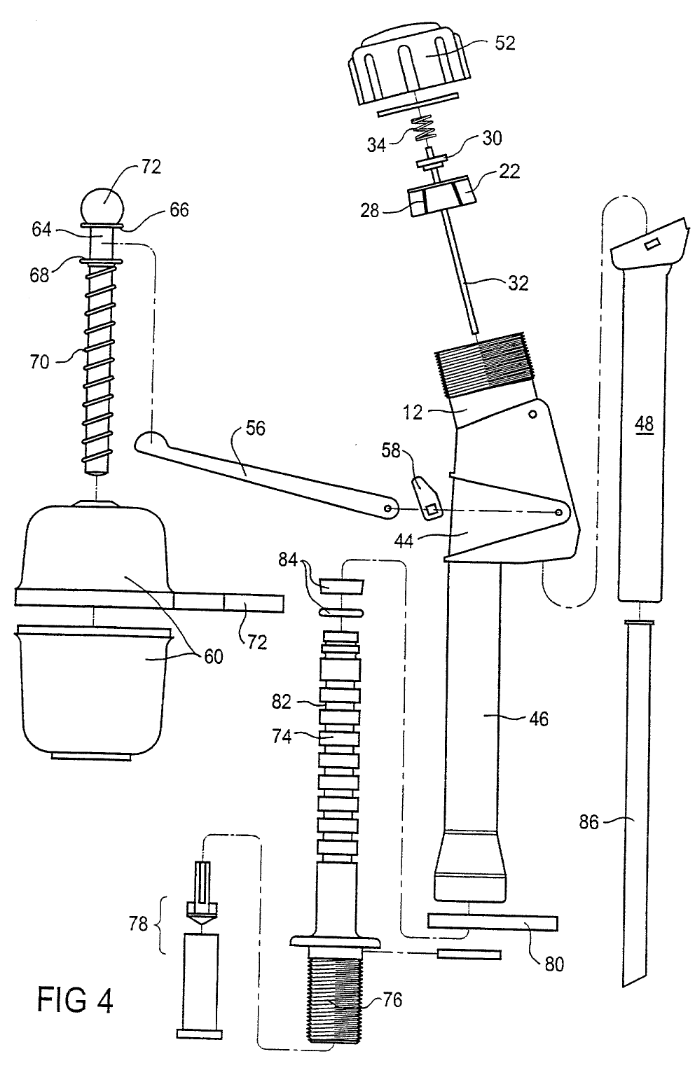

FIG. 4 is an exploded side view of the valve assembly of FIG. 3.

A preferred liquid flow control valve 10 according to the invention comprises a casing 12 having an inlet port 14 and an outlet port 16. The outlet port 16 is formed in a valve seat 18 which is located interiorly of the casing 10. An outlet conduit 20 is attached to the valve seat 18 and extends from the casing 10. The valve seat 18 is frustro-conical and provides a support for an inverted cup-shaped sealed member 22. Sealing member 22 is resiliently flexible and is formed from a plastic or rubber material and effectively divides the casing 10 into first and second chambers 24, 26. The skirt or side wall portion of sealing member 22 includes grooves 28 which, in conjunction with the interior surface of casing 10, provide passageways of small cross-sectional area for allowing restricted liquid flow from the first chamber 24 into the second chamber 26.

A valve operating member 30 is located in the second chamber 26 and includes a stem 32 which extends through an aperture 33 in sealing member 22, through valve seat 18 and into outlet conduit 20. A weak helical compressing spring 34 biases the operating member 30 towards a valve closed position.

The valve 10 is operable by an external actuator (to be described below) which tilts stem 32 sideways such that the operating member 30 unseals from the sealing member 22. FIG. 2 schematically illustrates the valve 10 in its opened position and with the stem 32 released from the actuator such that the valve can close. In this opened position, liquid flows from inlet port 14 into first chamber 24 and to outlet 16, as shown by arrow 36. Liquid also flows from the second chamber 26 between operating member 30 and sealing member 22, through the aperture 33 in sealing member 22 and into outlet 16, as shown by arrow 38. As soon as the stem 32 is released, the pressure of liquid in second chamber 26 assisted by the bias of spring 34 acts on the operating member 30 to move it into contact with sealing member 22 such that the flow represented by arrows 38 is restricted and eventually is stopped, that is, operating member 30 is moved into a substantially sealing relationship with sealing member 22. Simultaneously, the restricted liquid flow (represented by arrow 40) into second chamber 26 via grooves 28 in sealing member 22 causes a gradual increase in pressure in second chamber 26. The liquid flow shown by arrow 36 will tend to flex the skirt of sealing member 22 into contact with the interior surface of casing wall 12, however the grooves 28 ensure that the restricted flow 40 continues. This increasing pressure, relative to the reduced pressure zone at the outlet 16 (due to liquid flow therethrough) assisted by the bias of spring 34, controllably drives operating member 30 with sealing member 22 towards valve seat 18 thereby gradually reducing the flow represented by arrow 35 until the operating member 30 and sealing member 22 co-operatively establish a seal on the valve seat 18 thereby preventing further liquid flow through the valve.

It has been found that the closing of the valve 10, although controlled, is still positive. Indeed it is thought that immediately prior to the instant of closing, the pressure relationships between the first and second chambers 24, 26 and at the outlet port 16 are such that the pressure in the second chamber 26 momentarily increases above that in the first chamber 24 and this helps to positively close the valve 10, but without causing any undue water hammer. The sealing member 22, being resiliently flexible, flexes inwards during inwards closure and this helps to remove dirt or debris which may become lodged in the grooves 28 therein. The spring 34 assists the positive closure of the valve 10, however the valve 10 is still effectively operable without the spring 34, thus it may be omitted.

An inlet valve assembly 42 for a cistern, as illustrated in FIGS. 3 and 4, includes a valve similar to that of FIGS. 1 and 2 and accordingly the same reference numerals have been used to indicate corresponding features. The casing 12 is an extension on a body 44 to which an inlet pipe 46 and an outlet pipe 48 are connected. Body 44 includes a partition 50 which separates the inlet and outlet sides of the valve 10. Part of the casing 12 is provided by a screw-on cap 52 which includes a structure 54 for locating the compression spring 34. The stem 32 of operating member 30 extends into the outlet side of body 44 and is actuable by an actuating mechanism that comprises a lever 56 and cam 58 operable by a float 60.

Lever 56 is pivotally attached to the exterior of body 44 via a shaft 62 which extends transversely through body 44 and carries the cam 58 located within the body 44, and which is arranged to actuate the stem 32 of operating member 30. The outer end of lever 56 is loosely connected to float 60 such that displacement of the float causes the lever to pivot relative to body 44. This loose connection is provided by a Y configuration at the outer end of lever 56 which straddles a shaft 64 between two flanges 66, 68. The shaft 64 is attached to float 60 via a screwed portion 70 such that the position of the float 60 relative to the lever 56 is adjustable using a knob 72 at the top of shaft 64. A bracket 72 attached to float 60 extends therefrom and loosely surrounds inlet pipe 46 for guiding the up and down movement of the float 60 depended upon the water level in a cistern.

FIG. 3 illustrates the inlet valve assembly 42 with the float 60 in an upper position corresponding to a cistern being full of water. In this position the valve 10 is closed. When the cistern is flushed, the water level decreases the float 60 moves downwardly. This causes lever 56 to pivot which rotates shaft 62 and thus cam 58 (in an anti-clockwise direction with respect to FIG. 3) into actuating engagement with stem 32 to tilt it sideways. The tilting of stem 32 unseals operating member 30 thereby opening the valve 10 and allowing water to flow from inlet pipe 46 through inlet port 14, valve 10, outlet port 16 to outlet pipe 48 and thus fill the cistern. As the water level in the cistern rises it moves float 60 upwardly until eventually the cam 58 is moved to a non-actuating position relative to stem 32, at which point the operating member 30 is freed for the valve 10 to be controllably closed by the pressure which is developed in the second chamber 26, as described hereinabove.

The inlet pipe 46 includes a telescopic pipe 74 for adjusting the length of the inlet conduit. Pipe 74 includes an end portion 76 which is screw-threaded for attachment to the plumbing for a cistern and which also includes a check valve 78 for preventing back flow. Check valves are known and thus valve 78 will not be described in detail. Telescopic pipe 74 is lockable relative to inlet pipe 46 in selected adjustment positions by a detainer key 80 which clips around pipe 46 to protrude through opposed apertures therein (not shown) to seat within one of a series of annular grooves 82 formed along pipe 74. A seal 84 at the upper end of telescopic pipe 74 ensures there will be no water leakage around detainer key 80.

The outlet pipe 48 also includes a telescopic pipe 86 which is slidably adjustable within pipe 48.

The valve components may be manufactured from suitable materials as will be appreciated by persons skilled in the art. Such materials include plastics and/or non-corrosive metals. A valve assembly may for example have some components formed from plastics and others from metal, for example stainless steel. In one embodiment, all the main parts may be of plastics, apart from the stem 32 and spring 34 which may be of stainless steel.

The invention described herein is susceptible to variations, modifications and/or additions other than those specifically described and it is to be understood that the invention includes all such variations, modifications and/or additions which fall within the spirit and scope of the above description.

1. A liquid flow control valve comprising a casing and a sealing member within the casing, wherein the sealing member divides the casing into a first chamber and a second chamber,
wherein the sealing member provides for restricted liquid flow from the first chamber to the second chamber,
the casing including a liquid inlet port which opens into the first chamber and a liquid outlet port,
a valve operating member in the second chamber and operable on the sealing member and co-operable therewith to seal the outlet port, wherein the valve operating member is operable by liquid pressure due to liquid which flows into the second chamber from the first chamber via the sealing member to initially co-operate with the sealing member to seal the outlet port,
wherein the operating member is externally actuable to break the seal for liquid to flow from the first and second chambers through the outlet port and is released upon removal of the external actuation for operation by said liquid pressure,
wherein the restricted liquid flow into the second chamber and the pressure thereof relative to the liquid pressure at the outlet port provides for controlled closure of the valve.

2. A liquid flow control valve according to claim 1 including biasing means acting on said valve operating member to bias it towards a sealing relationship with said sealing member to seal said outlet port.

3. A liquid flow control valve according to claim 2 wherein said biasing means acts between the casing and the operating member.

4. A liquid flow control valve according to any one of claims 1 to 3 wherein the outlet port is located in a valve seat located within the first chamber adjacent the sealing member.

5. A liquid flow control valve according to any one of claims 1 to 4 wherein the sealing member is formed from a resilient material.

6. A liquid flow control valve according to any one of claims 1 to 5 wherein the sealing member is moveable within the casing.

7. A liquid flow control valve according to any one of claims 1 to 6 wherein said operating member includes a stem which passes through an aperture in said sealing member and through said outlet port, wherein said stem provides for external actuation of said operating member.

8. A liquid flow control valve according to any one of claims 1 to 7 wherein said sealing member includes at least one aperture in a portion thereof to provide restricted liquid flow from the first to the second chamber.

9. A liquid flow control valve according to claim 7 wherein said sealing member includes a skirt having one or more grooves therein to provide restricted liquid flow from the first to the second chamber.

10. A liquid flow control valve according to claim 9 wherein said skirt is flexible.

11. A liquid flow control valve according to any one of claims 7 to 10 further including stem actuating means which acts on said stem to break the seal between the operating member and the sealing member when said stem actuating means moves to an actuating position, and wherein said stem actuating means ceases to act on said stem when in a non-actuating position.

12. A liquid flow control valve according to claim 11 for use in a cistern having a selected full water level and wherein said stem actuating means includes a float such that when the water level in the cistern is below the selected level said float acts on said stem actuating means to act on said stem to break the seal between said operating member and sealing member, and when the water level in the cistern is at or above the selected level, the float and actuating means cease to act on said stem.

13. A liquid flow control valve according to any one of claims 1 to 12 wherein said liquid inlet port includes a passage of adjustable length.

14. A liquid flow control valve according to any one of claims 1 to 13 wherein said outlet port includes a passage of adjustable length.

15. A liquid flow control valve according to claim 1 substantially as hereinbefore described with reference to any one of the drawings.
